(19) United States
(12) Patent Application Publication
(10) Pub. No.: US 2023/0222499 A1
(43) Pub. Date: Jul. 13, 2023

(54) METHOD AND SYSTEM FOR IDENTIFYING DUPLICATE DATA

(71) Applicant: JPMorgan Chase Bank, N.A., New York, NY (US)

(72) Inventors: Mike BAXTER, Tampa, FL (US); Debbie CHADBOURNE, Riverview, FL (US); Ruchika PATIL, Thane (IN); Vishesh SRIVASTAVA, Sitapur (IN)

(73) Assignee: JPMorgan Chase Bank, N.A., New York, NY (US)

(21) Appl. No.: 17/651,976

(22) Filed: Feb. 22, 2022

(30) Foreign Application Priority Data
Jan. 8, 2022 (IN) 202211001114

(51) Int. Cl. G06Q 20/38; G06Q 20/10; G06Q 20/02

(52) U.S. Cl. CPC G06Q 20/389; G06Q 20/10; G06Q 20/023

(57) ABSTRACT

A method for facilitating identification of duplicate data from substantially similar datasets is disclosed. The method includes receiving transaction data from a source, the transaction data including a transaction record that relates to substantially similar electronic fund transfers; marking the transaction record based on a first criterion; retrieving, based on a result of the marking, information that correspond to the transaction record, the information relating to historical data for a predetermined period of time; tagging the transaction record based on a second criterion and the retrieved information; and determining whether the transaction record is marked and tagged.

### CROSS-REFERENCE TO RELATED APPLICATIONS

This application claims the benefit of Indian Provisional Patent Application No. 202211001114, filed Jan. 8, 2022, which is hereby incorporated by reference in its entirety.

### BACKGROUND

### 1. Field of the Disclosure

This technology generally relates to methods and systems for identifying duplicate data, and more particularly to methods and systems for facilitating identification of duplicate data from substantially similar datasets by using predetermined criteria and corresponding historical data.

### 2. Background Information

Many business entities must interpret and process large volumes of data such as, for example, electronic funds-transfer data from an automated clearing house (ACH) system to facilitate business operations. Often, these large volumes of data include many nonduplicate datasets that have substantially similar compositions. Historically, implementation of conventional techniques for identifying duplicate transactions in datasets with substantially similar data composition has resulted in varying degrees of success with respect to accurately and efficiently distinguishing duplicate data entries from false positives.

One drawback of using the conventional techniques is that in many instances, the nonduplicate datasets are virtually indistinguishable due to the substantially similar data composition. As a result, the nonduplicate datasets are mistakenly identified as duplicate datasets, which results in many false positives. Additionally, due to the many false positives, corrective actions may not be initiated in a timely manner to correct truly duplicate datasets.

Therefore, there is a need to identify truly duplicate data from substantially similar datasets by using predetermined criteria and corresponding historical data to facilitate effective alerting and timely initiation of resolution actions.

### SUMMARY

The present disclosure, through one or more of its various aspects, embodiments, and/or specific features or sub-components, provides, inter alia, various systems, servers, devices, methods, media, programs, and platforms for facilitating identification of duplicate data from substantially similar datasets by using predetermined criteria and corresponding historical data.

According to an aspect of the present disclosure, a method for facilitating identification of duplicate data from substantially similar datasets is disclosed. The method is implemented by at least one processor. The method may include receiving transaction data from at least one source, the transaction data may include at least one transaction record that relates to a plurality of substantially similar electronic fund transfers; marking the at least one transaction record based on at least one first criterion; retrieving, based on a result of the marking, information that relates to the at least one transaction record, the information may relate to historical data for a predetermined period of time; tagging the at least one transaction record based on at least one second criterion and the retrieved information; and determining whether the at least one transaction record is marked and tagged.

In accordance with an exemplary embodiment, the at least one first criterion may include at least one from among an origin identifier, a company identifier, an account number, a bank routing number, an amount, a transaction code, an individual identifier, and an individual name.

In accordance with an exemplary embodiment, the at least one second criterion may include at least one from among a threshold number of duplicate records and a threshold percentage of duplicate records, the threshold percentage of duplicate records may include a mean value and a standard deviation that correspond to the historical data.

In accordance with an exemplary embodiment, the method may further include categorizing the at least one transaction record as a potential duplicate record based on at least one third criterion when the at least one transaction record is marked and tagged; generating at least one alert based on a result of the categorizing, the at least one alert may include information that relates to the at least one transaction record, the marking, the tagging, the categorizing, and an alert level; and transmitting the at least one alert to a user.

In accordance with an exemplary embodiment, the at least one third criterion may include at least one from among an original trace, an entry descriptor, a discretionary datum, a descriptive date, and an addendum.

In accordance with an exemplary embodiment, the method may further include categorizing the at least one transaction record as a potential duplicate record based on at least one fourth criterion when the at least one transaction record is marked; generating at least one alert based on a result of the categorizing, the at least one alert may include information that relates to the at least one transaction record, the marking, the categorizing, and an alert level; and transmitting the at least one alert to a user.

In accordance with an exemplary embodiment, the at least one fourth criterion may include at least one from among a duplicate count threshold number, an original trace, an entry descriptor, a discretionary datum, a descriptive date, and an addendum.

In accordance with an exemplary embodiment, prior to marking the at least one transaction, the method may further include identifying at least one data element from the transaction data; and generating, from the at least one data element, at least one structured data set based on a predetermined characteristic of the at least one transaction record, the structured data set may relate to at least one data table that includes a plurality of transaction records with a shared characteristic.

In accordance with an exemplary embodiment, the method may further include associating a time value and at least one retention policy with the transaction data, the at least one retention policy may relate to an amount of time to persist the transaction data; and persisting the transaction data and the corresponding association in a repository.

According to an aspect of the present disclosure, a computing device configured to implement an execution of a method for facilitating identification of duplicate data from substantially similar datasets is disclosed. The computing device including a processor; a memory; and a communication interface coupled to each of the processor and the memory, wherein the processor may be configured to receive transaction data from at least one source, the transaction data may include at least one transaction record that relates to a plurality of substantially similar electronic fund transfers; mark the at least one transaction record based on at least one first criterion; retrieve, based on a result of the marking, information that relates to the at least one transaction record, the information may relate to historical data for a predetermined period of time; tag the at least one transaction record based on at least one second criterion and the retrieved information; and determine whether the at least one transaction record is marked and tagged.

In accordance with an exemplary embodiment, the at least one first criterion may include at least one from among an origin identifier, a company identifier, an account number, a bank routing number, an amount, a transaction code, an individual identifier, and an individual name.

In accordance with an exemplary embodiment, the at least one second criterion may include at least one from among a threshold number of duplicate records and a threshold percentage of duplicate records, the threshold percentage of duplicate records may include a mean value and a standard deviation that correspond to the historical data.

In accordance with an exemplary embodiment, the processor may be further configured to categorize the at least one transaction record as a potential duplicate record based on at least one third criterion when the at least one transaction record is marked and tagged; generate at least one alert based on a result of the categorizing, the at least one alert may include information that relates to the at least one transaction record, the marking, the tagging, the categorizing, and an alert level; and transmit the at least one alert to a user.

In accordance with an exemplary embodiment, the at least one third criterion may include at least one from among an original trace, an entry descriptor, a discretionary datum, a descriptive date, and an addendum.

In accordance with an exemplary embodiment, the processor may be further configured to categorize the at least one transaction record as a potential duplicate record based on at least one fourth criterion when the at least one transaction record is marked; generate at least one alert based on a result of the categorizing, the at least one alert may include information that relates to the at least one transaction record, the marking, the categorizing, and an alert level; and transmit the at least one alert to a user.

In accordance with an exemplary embodiment, the at least one fourth criterion may include at least one from among a duplicate count threshold number, an original trace, an entry descriptor, a discretionary datum, a descriptive date, and an addendum.

In accordance with an exemplary embodiment, prior to marking the at least one transaction, the processor may be further configured to identify at least one data element from the transaction data; and generate, from the at least one data element, at least one structured data set based on a predetermined characteristic of the at least one transaction record, the structured data set may relate to at least one data table that includes a plurality of transaction records with a shared characteristic.

In accordance with an exemplary embodiment, the processor may be further configured to associate a time value and at least one retention policy with the transaction data, the at least one retention policy may relate to an amount of time to persist the transaction data; and persist the transaction data and the corresponding association in a repository.

According to an aspect of the present disclosure, a non-transitory computer readable storage medium storing instructions for facilitating identification of duplicate data from substantially similar datasets is disclosed. The storage medium including executable code which, when executed by a processor, may cause the processor to receive transaction data from at least one source, the transaction data may include at least one transaction record that relates to a plurality of substantially similar electronic fund transfers; mark the at least one transaction record based on at least one first criterion; retrieve, based on a result of the marking, information that relates to the at least one transaction record, the information may relate to historical data for a predetermined period of time; tag the at least one transaction record based on at least one second criterion and the retrieved information; and determine whether the at least one transaction record is marked and tagged.

In accordance with an exemplary embodiment, the executable code may further cause the processor to categorize the at least one transaction record as a potential duplicate record based on at least one third criterion when the at least one transaction record is marked and tagged; generate at least one alert based on a result of the categorizing, the at least one alert may include information that relates to the at least one transaction record, the marking, the tagging, the categorizing, and an alert level; and transmit the at least one alert to a user.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating identification of duplicate data from substantially similar datasets by using predetermined criteria and corresponding historical data.

FIG. 4 is a flowchart of an exemplary process for implementing a method for facilitating identification of duplicate data from substantially similar datasets by using predetermined criteria and corresponding historical data.

FIG. 5 is a flow diagram of an exemplary process for implementing a method for facilitating identification of duplicate data from substantially similar datasets by using predetermined criteria and corresponding historical data.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

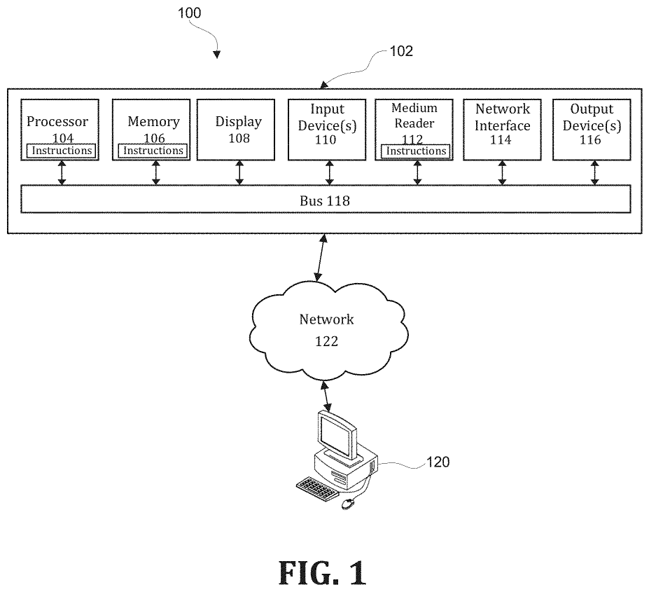

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating identification of duplicate data from substantially similar datasets by using predetermined criteria and corresponding historical data.

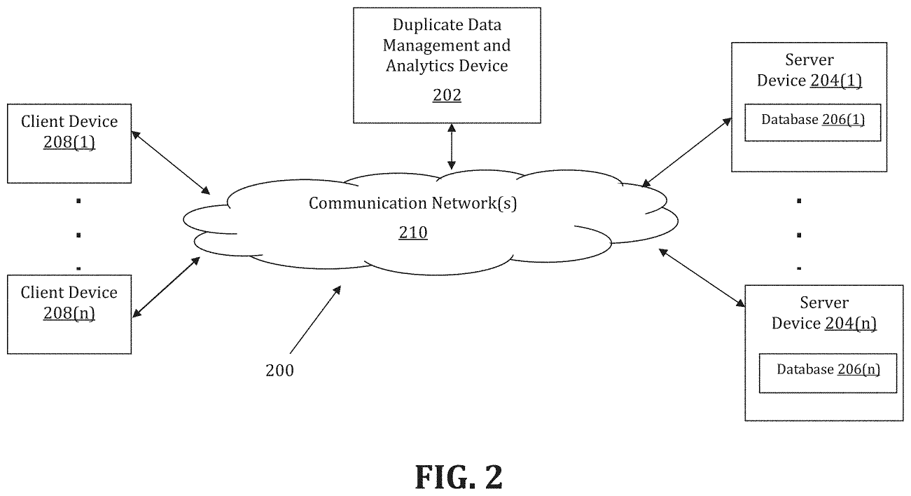

Referring to FIG. 2, a schematic of an exemplary network environment 200 for implementing a method for facilitating identification of duplicate data from substantially similar datasets by using predetermined criteria and corresponding historical data is illustrated. In an exemplary embodiment, the method is executable on any networked computer platform, such as, for example, a personal computer (PC).

The method for facilitating identification of duplicate data from substantially similar datasets by using predetermined criteria and corresponding historical data may be implemented by a Duplicate Data Management and Analytics (DDMA) device 202. The DDMA device 202 may be the same or similar to the computer system 102 as described with respect to FIG. 1. The DDMA device 202 may store one or more applications that can include executable instructions that, when executed by the DDMA device 202, cause the DDMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DDMA device 202 itself, may be located in virtual server(s) running in a cloud-based computing environment rather than being tied to one or more specific physical network computing devices. Also, the application(s) may be running in one or more virtual machines (VMs) executing on the DDMA device 202. Additionally, in one or more embodiments of this technology, virtual machine(s) running on the DDMA device 202 may be managed or supervised by a hypervisor.

In the network environment 200 of FIG. 2, the DDMA device 202 is coupled to a plurality of server devices 204(1)-204(n) that hosts a plurality of databases 206(1)-206(n), and also to a plurality of client devices 208(1)-208(n) via communication network(s) 210. A communication interface of the DDMA device 202, such as the network interface 114 of the computer system 102 of FIG. 1, operatively couples and communicates between the DDMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DDMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DDMA devices that efficiently implement a method for facilitating identification of duplicate data from substantially similar datasets by using predetermined criteria and corresponding historical data.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DDMA device 202 may be a standalone device or integrated with one or more other devices or apparatuses, such as one or more of the server devices 204(1)-204(n), for example. In one particular example, the DDMA device 202 may include or be hosted by one of the server devices 204(1)-204(n), and other arrangements are also possible. Moreover, one or more of the devices of the DDMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DDMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to transaction data, transaction records, electronic fund transfers, predetermined criteria, historical data, alerts, structured data sets, data elements, time values, and retention policies.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DDMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DDMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DDMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DDMA device 202, the server devices 204(1)-204(n), or the client devices 208(1)-208(n), for example, may be configured to operate as virtual instances on the same physical machine. In other words, one or more of the DDMA device 202, the server devices 204(1)-204(n), or the client devices 208(1)-208(n) may operate on the same physical device rather than as separate devices communicating through communication network(s) 210. Additionally, there may be more or fewer DDMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

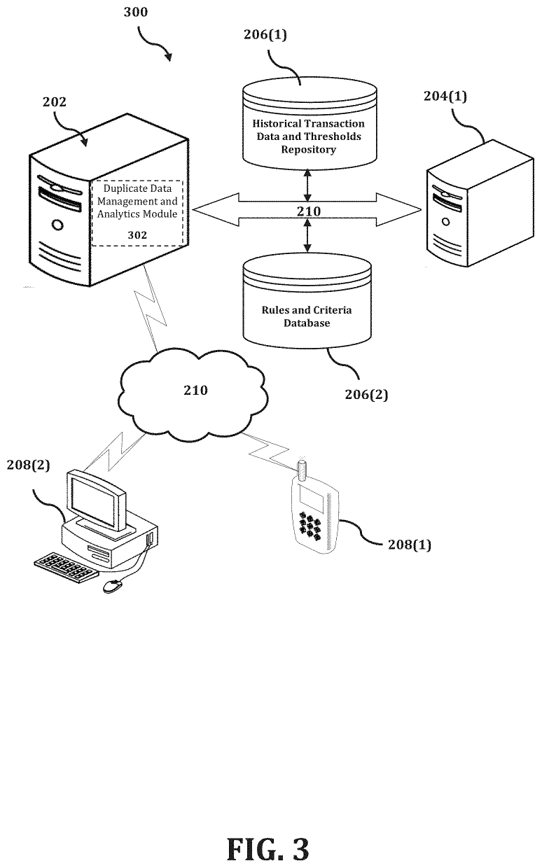

The DDMA device 202 is described and shown in FIG. 3 as including a duplicate data management and analytics module 302, although it may include other rules, policies, modules, databases, or applications, for example. As will be described below, the duplicate data management and analytics module 302 is configured to implement a method for facilitating identification of duplicate data from substantially similar datasets by using predetermined criteria and corresponding historical data.

An exemplary process 300 for implementing a mechanism for facilitating identification of duplicate data from substantially similar datasets by using predetermined criteria and corresponding historical data by utilizing the network environment of FIG. 2 is shown as being executed in FIG. 3. Specifically, a first client device 208(1) and a second client device 208(2) are illustrated as being in communication with DDMA device 202. In this regard, the first client device 208(1) and the second client device 208(2) may be “clients” of the DDMA device 202 and are described herein as such. Nevertheless, it is to be known and understood that the first client device 208(1) and/or the second client device 208(2) need not necessarily be “clients” of the DDMA device 202, or any entity described in association therewith herein. Any additional or alternative relationship may exist between either or both of the first client device 208(1) and the second client device 208(2) and the DDMA device 202, or no relationship may exist.

Further, DDMA device 202 is illustrated as being able to access a historical transaction data and thresholds repository 206(1) and a rules and criteria database 206(2). The duplicate data management and analytics module 302 may be configured to access these databases for implementing a method for facilitating identification of duplicate data from substantially similar datasets by using predetermined criteria and corresponding historical data.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DDMA device 202 via broadband or cellular communication. Of course, these embodiments are merely exemplary and are not limiting or exhaustive.

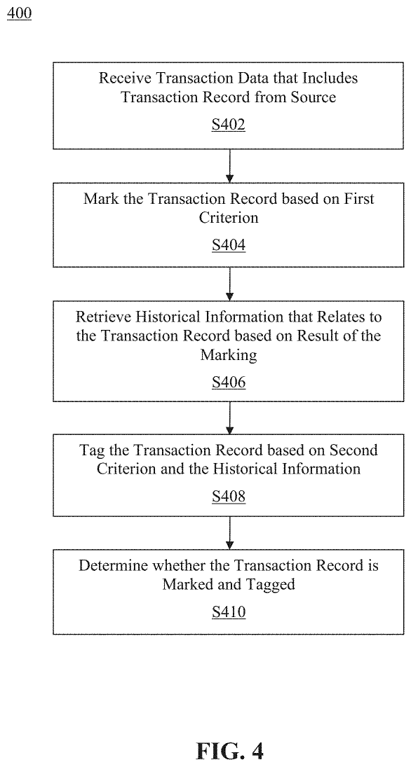

Upon being started, the duplicate data management and analytics module 302 executes a process for facilitating identification of duplicate data from substantially similar datasets by using predetermined criteria and corresponding historical data. An exemplary process for facilitating identification of duplicate data from substantially similar datasets by using predetermined criteria and corresponding historical data is generally indicated at flowchart 400 in FIG. 4.

In the process 400 of FIG. 4, at step S402, transaction data may be received from a source. The transaction data may include a transaction record that relates to a plurality of substantially similar electronic fund transfers. In an exemplary embodiment, the transaction data may correspond to an electronic data format that i s received from a funds-transfer system such as, for example, an automated clearing house (ACH) system that facilitates electronic payments. The ACH system may relate to a computer-based electronic network for processing transactions between participating financial institutions. In an exemplary embodiment, the transaction data may include substantially similar datasets that are identical or nearly identical to another dataset in the transaction data. For example, transaction records may be substantially similar for recurring bill payment transactions where an amount is the same and the payment origination source is the same.

In another exemplary embodiment, the transaction data may relate to any electronic datasets. The electronic datasets may include information relating to quantities, characters, and/or symbols on which operations are performed by a computer. As will be appreciated by a person of ordinary skill in the art, the electronic datasets may correspond to facts, statistics, and/or items of information that is accessed and manipulated via a computing device.

In another exemplary embodiment, the source may include at least one from among a first-party source and a third-party source. The first-party source may correspond to an internal data management system such as, for example, a proprietary data management system and the third-party data source may correspond to an external data management system such as, for example, vendor data. In another exemplary embodiment, the transaction data may be received as preprocessed data from the source. The transaction data may be preprocessed based on a predetermined format by the source.

In another exemplary embodiment, the transaction data may be received as raw and unprocessed data from the source. To process the raw data, data elements may be identified from the received transaction data. Then, structured data sets may be generated from the data elements based on a predetermined characteristic of the transaction records in the transaction data. The structured data set may relate to data tables that include a plurality of transaction records with a shared characteristic. In another exemplary embodiment, the data tables may correspond to an origination debits data table, an origination credit data table, a received debit data table, and a received credit data table. The data tables may be augmented with additional data such as, for example, a run number, a load type, and a load status by inserting the additional data into preconfigured data fields.

In another exemplary embodiment, data corresponding to the transaction records may be identified and retrieved to augment the data tables. Corresponding data such as, for example, origin data, account data, transaction code data, amount data, individual identifier data, company identifier data, individual name data, and routing data may be identified and added to the data tables. In another exemplary embodiment, the data tables may be generated based on a batch quantity to facilitate batch processing of the transaction data. For example, transaction records may be added to a data table until a count of 500 is satisfied.

At step S404, the transaction record may be marked based on a first criterion. The first criterion may relate to basic criteria for determining whether any transaction record in the transaction data should be further reviewed by the claimed invention consistent with present disclosures. In an exemplary embodiment, the first criterion may include at least one from among an origin identifier, a company identifier, an account number, a bank routing number, an amount, a transaction code, an individual identifier, and an individual name. The first criterion may relate to a characteristic of the transaction record. In another exemplary embodiment, transaction records may be marked when the transaction records share substantially similar first criteria. The transaction records may be marked when the transaction records share any combination of the first criteria.

At step S406, information that corresponds to the transaction record may be retrieved based on a result of the marking. The information may relate to historical data for a predetermined period of time such as, for example, a rolling three-day period of time. In an exemplary embodiment, the information may include corresponding reference data, corresponding data tables, and corresponding status tables that are retrieved according to the predetermined period of time. The information may also include statistical data such as, for example, captured duplicate data and total duplicate counts data for the predetermined period of time. In another exemplary embodiment, various components of the information may be retrieved as required based on different timeframes. For example, the reference tables, data tables, and status tables may be retrieved for a rolling three-day period while threshold calculations are based on historical data from a past year.

In another exemplary embodiment, the statistical data may be retrieved from first-party data systems such as, for example, data systems of internal clients as well as from third-party data systems such as, for example, data systems of external clients from other financial institutions. The statistical data may include values such as, for example, mean values and standard deviation values that represents the historical data. In another exemplary embodiment, the statistical data may correspond to a predetermined pattern that represents duplicate transaction records for a given timeframe such as, for example, for a given day of the week. The pattern may be realized by using a predictive model that is trained based on the historical data.

In another exemplary embodiment, the predictive model may include at least one from among a machine learning model, a statistical model, a mathematical model, a process model, and a data model. The predictive model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S408, the transaction record may be tagged based on a second criterion and the retrieved information. The second criterion may relate to threshold criteria for determining whether any transaction record in the transaction data should be tagged for further review. In an exemplary embodiment, the second criterion may include at least one from among a threshold number of duplicate records and a threshold percentage of duplicate records. The threshold number of duplicate records and the threshold percentage of duplicate records may be predetermined based on a predetermined guideline. The threshold percentage of duplicate records may include a mean value and a standard deviation that correspond to the historical data. In another exemplary embodiment, the transaction record may be tagged based on satisfaction of the threshold criteria. The transaction records may be tagged when the transaction record satisfies any combination of the threshold criteria.

At step S410, whether the transaction record is marked and tagged may be determined. In an exemplary embodiment, the transaction record may be categorized as a potential duplicate record based on a third criterion when the transaction record is marked and tagged. The transaction record may only be categorized as such when the transaction record satisfies both the first criterion and the second criterion. In another exemplary embodiment, the third criterion may include at least one from among an original trace, an entry descriptor, a discretionary datum, a descriptive date, and an addendum.

In another exemplary embodiment, an alert may be generated based on a result of the categorizing. The alert may include information that relates to the transaction record, the marking, the tagging, the categorizing, and a corresponding alert level. The corresponding alert level may include a high-alert level, a medium-alert level, and a low-alert level. Then, the alert may be transmitted to a user. In another exemplary embodiment, the alert may be transmitted based on the corresponding alert level. For example, a high-alert level may require escalation for supervisory review by a specific group of users.

In another exemplary embodiment, the transaction record may be categorized as a potential duplicate record based on a fourth criterion when the transaction record is marked. The transaction record may only be categorized as such when the transaction record only satisfies the first criterion but does not satisfy the second criterion. In another exemplary embodiment, the fourth criterion may include at least one from among a duplicate count threshold number, an original trace, an entry descriptor, a discretionary datum, a descriptive date, and an addendum.

In another exemplary embodiment, an alert may be generated based on a result of the categorizing. The alert may include information that relates to the transaction record, the marking, the categorizing, and a corresponding alert level. The corresponding alert level may include a high-alert level, a medium-alert level, and a low-alert level. Then, the alert may be transmitted to a user. In another exemplary embodiment, the alert may be transmitted based on the corresponding alert level. For example, a high-alert level may require escalation for supervisory review by a specific group of users.

In another exemplary embodiment, a time value and a retention policy may be associated with the transaction data. The retention policy may relate to an among of time to persist the transaction data. Then, the transaction data and the corresponding association may be persisted in a repository. In another exemplary embodiment, persisting the transaction data after processing creates a rolling collection of historical data that is usable to determine duplicate transaction records consistent with present disclosures.

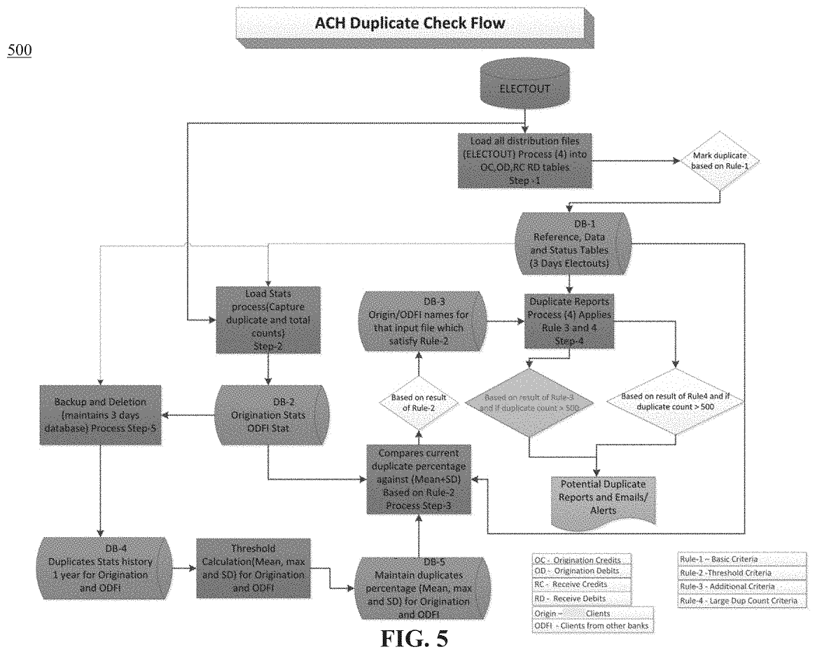

FIG. 5 is a flow diagram 500 of an exemplary process for implementing a method for facilitating identification of duplicate data from substantially similar datasets by using predetermined criteria and corresponding historical data. In FIG. 5, various computing components may perform the illustrated actions in sequence as well as in parallel to realize efficiency improvements. The computing components may include applications that are connected via a network interface.

In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, the microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

Accordingly, with this technology, an optimized process for facilitating identification of duplicate data from substantially similar datasets by using predetermined criteria and corresponding historical data is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for facilitating identification of duplicate data from datasets, the method being implemented by at least one processor, the method comprising:
generating, by the at least one processor, a predictive model by using a decision tree;
assessing, by the at least one processor, the predictive model to determine whether at least one rate is within a predetermined range;
deploying, by the at least one processor, the predictive model based on a result of the assessment;
receiving, by the at least one processor, transaction data from at least one source, the transaction data including at least one transaction record that relates to a plurality of electronic fund transfers;
marking, by the at least one processor, the at least one transaction record based on at least one first criterion;
retrieving, by the at least one processor based on a result of the marking, information that corresponds to the at least one transaction record by,
training, by the at least one processor, the predictive model based on historical data that relates to the at least one transaction record, the predictive model including a machine learning model; and
identifying, by the at least one processor using the predictive model, at least one pattern that represents at least one duplicate transaction record,
wherein the information includes the identified at least one pattern and the historical data for a predetermined period of time;
tagging, by the at least one processor, the at least one transaction record based on at least one second criterion and the retrieved information; and
determining, by the at least one processor, whether the at least one transaction record is marked and tagged.

2. The method of claim 1, wherein the at least one first criterion includes at least one from among an origin identifier, a company identifier, an account number, a bank routing number, an amount, a transaction code, an individual identifier, and an individual name.

3. The method of claim 1, wherein the at least one second criterion includes at least one from among a threshold number of duplicate records and a threshold percentage of duplicate records, the threshold percentage of duplicate records including a mean value and a standard deviation that correspond to the historical data.

4. The method of claim 1, further comprising:
categorizing, by the at least one processor, the at least one transaction record as a potential duplicate record based on at least one third criterion when the at least one transaction record is marked and tagged;
generating, by the at least one processor, at least one alert based on a result of the categorizing, the at least one alert including information that relates to the at least one transaction record, the marking, the tagging, the categorizing, and an alert level; and
transmitting, by the at least one processor, the at least one alert to a user.

5. The method of claim 4, wherein the at least one third criterion includes at least one from among an original trace, an entry descriptor, a discretionary datum, a descriptive date, and an addendum.

6. The method of claim 1, further comprising:
categorizing, by the at least one processor, the at least one transaction record as a potential duplicate record based on at least one fourth criterion when the at least one transaction record is marked;
generating, by the at least one processor, at least one alert based on a result of the categorizing, the at least one alert including information that relates to the at least one transaction record, the marking, the categorizing, and an alert level; and
transmitting, by the at least one processor, the at least one alert to a user.

7. The method of claim 6, wherein the at least one fourth criterion includes at least one from among a duplicate count threshold number, an original trace, an entry descriptor, a discretionary datum, a descriptive date, and an addendum.

8. The method of claim 1, wherein, prior to marking the at least one transaction, the method further comprises:
identifying, by the at least one processor, at least one data element from the transaction data; and
generating, by the at least one processor from the at least one data element, at least one structured data set based on a predetermined characteristic of the at least one transaction record, the structured data set relating to at least one data table that includes a plurality of transaction records with a shared characteristic.

9. The method of claim 1, further comprising:
associating, by the at least one processor, a time value and at least one retention policy with the transaction data, the at least one retention policy relating to an amount of time to persist the transaction data; and
persisting, by the at least one processor, the transaction data and the corresponding association in a repository.

10. A computing device configured to implement an execution of a method for facilitating identification of duplicate data from datasets, the computing device comprising:
a processor;
a memory; and
a communication interface coupled to each of the processor and the memory,
wherein the processor is configured to:
generate a predictive model by using a decision tree;
assess the predictive model to determine whether at least one rate is within a predetermined range;
deploy the predictive model based on a result of the assessment;
receive transaction data from at least one source, the transaction data including at least one transaction record that relates to a plurality of electronic fund transfers;
mark the at least one transaction record based on at least one first criterion;
retrieve, based on a result of the marking, information that corresponds to the at least one transaction record by causing the processor to:
train the predictive model based on historical data that relates to the at least one transaction record, the predictive model including a machine learning model; and
identify, by using the predictive model, at least one pattern that represents at least one duplicate transaction record,
wherein the information includes the identified at least one pattern and the historical data for a predetermined period of time;
tag the at least one transaction record based on at least one second criterion and the retrieved information; and
determine whether the at least one transaction record is marked and tagged.

11. The computing device of claim 10, wherein the at least one first criterion includes at least one from among an origin identifier, a company identifier, an account number, a bank routing number, an amount, a transaction code, an individual identifier, and an individual name.

12. The computing device of claim 10, wherein the at least one second criterion includes at least one from among a threshold number of duplicate records and a threshold percentage of duplicate records, the threshold percentage of duplicate records including a mean value and a standard deviation that correspond to the historical data.

13. The computing device of claim 10, wherein the processor is further configured to:
categorize the at least one transaction record as a potential duplicate record based on at least one third criterion when the at least one transaction record is marked and tagged;
generate at least one alert based on a result of the categorizing, the at least one alert including information that relates to the at least one transaction record, the marking, the tagging, the categorizing, and an alert level; and
transmit the at least one alert to a user.

14. The computing device of claim 13, wherein the at least one third criterion includes at least one from among an original trace, an entry descriptor, a discretionary datum, a descriptive date, and an addendum.

15. The computing device of claim 10, wherein the processor is further configured to:
categorize the at least one transaction record as a potential duplicate record based on at least one fourth criterion when the at least one transaction record is marked;
generate at least one alert based on a result of the categorizing, the at least one alert including information that relates to the at least one transaction record, the marking, the categorizing, and an alert level; and
transmit the at least one alert to a user.

16. The computing device of claim 15, wherein the at least one fourth criterion includes at least one from among a duplicate count threshold number, an original trace, an entry descriptor, a discretionary datum, a descriptive date, and an addendum.

17. The computing device of claim 10, wherein, prior to marking the at least one transaction, the processor is further configured to:
identify at least one data element from the transaction data; and
generate, from the at least one data element, at least one structured data set based on a predetermined characteristic of the at least one transaction record, the structured data set relating to at least one data table that includes a plurality of transaction records with a shared characteristic.

18. The computing device of claim 10, wherein the processor is further configured to:
associate a time value and at least one retention policy with the transaction data, the at least one retention policy relating to an amount of time to persist the transaction data; and
persist the transaction data and the corresponding association in a repository.

19. A non-transitory computer readable storage medium storing instructions for facilitating identification of duplicate data from datasets, the storage medium comprising executable code which, when executed by a processor, causes the processor to:
generate a predictive model by using a decision tree;
assess the predictive model to determine whether at least one rate is within a predetermined range;
deploy the predictive model based on a result of the assessment;
receive transaction data from at least one source, the transaction data including at least one transaction record that relates to a plurality of electronic fund transfers;
mark the at least one transaction record based on at least one first criterion;
retrieve, based on a result of the marking, information that corresponds to the at least one transaction record by causing the processor to:
train the predictive model based on historical data that relates to the at least one transaction record, the predictive model including a machine learning model; and
identify, by using the predictive model, at least one pattern that represents at least one duplicate transaction record,
wherein the information includes the identified at least one pattern and the historical data for a predetermined period of time;
tag the at least one transaction record based on at least one second criterion and the retrieved information; and
determine whether the at least one transaction record is marked and tagged.

20. The storage medium of claim 19, wherein the executable code further causes the processor to:
categorize the at least one transaction record as a potential duplicate record based on at least one third criterion when the at least one transaction record is marked and tagged;
generate at least one alert based on a result of the categorizing, the at least one alert including information that relates to the at least one transaction record, the marking, the tagging, the categorizing, and an alert level; and
transmit the at least one alert to a user.
